(19) United States
(12) Patent Application Publication
(10) Pub. No.: US 2016/0036155 A1
(43) Pub. Date: Feb. 4, 2016

(54) CONNECTOR

(71) Applicant: YAZAKI CORPORATION, Tokyo (JP)

(72) Inventors: Masayuki KATAOKA, Shizuoka (JP); Fuminori SUGIYAMA, Shizuoka (JP)

(21) Appl. No.: 14/884,470

(22) Filed: Oct. 15, 2015

Related U.S. Application Data
(63) Continuation of application No. PCT/JP2014/061062, filed on Apr. 18, 2014.

(30) Foreign Application Priority Data
Apr. 25, 2013 (JP) 2013-092245

(51) Int. Cl. H01R 13/405

(52) U.S. Cl. CPC H01R 13/405

(57) ABSTRACT

A terminal fitting of a connector includes an electrical-contact portion, a wire-connection portion, and a link portion for the electrical-contact portion and the wire-connection portion. The link portion is formed in a substantially crank shape including a step portion, a plate portion arranged at an electrical-contact portion side, and a plate portion arranged at a wire-connection portion side, having the step portion between the plate portion and the plate portion. The plate portion at the wire-connection portion side is formed with a plurality of recessed portions. The recessed portions are arranged and formed at predetermined positions on an outer surface of the plate portion in an entire peripheral direction. Further, the recessed portions are formed in a shape in which at least a part of an intermediate portion displaces outward from a position of an opening with respect to the opening.

### CROSS REFERENCE TO RELATED APPLICATIONS

This application is a continuation application of International Application No. PCT/JP2014/061062, filed on Apr. 18, 2014, which claims priority to Japanese Patent Application No. 2013-092245, filed on Apr. 25, 2013, the entire contents of which are incorporated by reference herein.

### BACKGROUND

1. Technical Field

The present invention relates to a connector including a terminal fitting having a plate portion and a resin connector housing.

2. Description of the Related Art

The connector provided at a terminal of a wire harness and serving as an electrical contact portion has various configurations and structures for, for example, high voltage and low voltage depending on a form of the wire harness. For example, as a high-voltage connector, a shield connector is known (refer to Japanese Patent Laid-Open Publication No. 2012-226832).

As illustrated in FIGS. 11 and 12, a shield connector 101 is provided at a terminal of the wire harness including a plurality of high-voltage wires 102, a cylindrical shielding member (not shown) for covering the plurality of high-voltage wires 102. Further the shield connector 101 includes a metal terminal fitting 103 connected to a conductor of the high-voltage wire 102, a resin connector housing 104 storing the terminal fitting 103, a resin terminal locking member 105 assembled to a front side of the connector housing 104, a resin rear holder 106 assembled to a back side of the connector housing 104, a metal shield shell 107 provided outside the connector housing 104, a metal shield ring 108 for fixing a terminal of the above-described shielding member to the shield shell 107, and a plurality of types of waterproof units.

The above-described waterproof unit includes an O ring 109, a seal ring 110, and a unit packing 111. The O ring 109 prevents a water leakage between the plate portion 112 of the terminal fitting 103 and the connector housing 104. Further, the seal ring 110 prevents a water leakage between the high-voltage wire 102 and the connector housing 104. The unit packing 111 prevents a water leakage between the connector housing 104 and a high-voltage device (not shown).

### SUMMARY OF THE INVENTION

It can be known that the above-described conventional shield connector 101 includes a great number of components (there are a great number of components). Therefore, it causes a problem of high costs for components and assembling. Further, there are other problems of difficult component control and difficult space saving of connectors.

An object of the present invention is to provide, in consideration of the above-described problems, a connector being capable of reducing the number of components to reduce costs, facilitating the component control, and realizing saving the space.

An aspect of the present invention is a connector including a terminal fitting including a plate portion; and a resin connector housing, wherein the terminal fitting is fixed by insert-molding the plate portion to the connector housing; wherein the plate portion has a plurality of recessed portions arranged and formed at predetermined positions on an outer surface of the plate portion in an entire peripheral direction; and wherein each of the plurality of recessed portions has a cross-sectional shape in which at least apart of an intermediate portion or a bottom portion displaces outward from a position of an opening of the recessed portion, with respect to the opening.

The plurality of recessed portions may be alternately arranged in a plurality of rows.

The plurality of recessed portions may be formed by processing the outer surface of the plate portion to be recessed in an oblique direction.

The plurality of recessed portions may be formed by an additional processing or a chemical treatment after the formation of recess on the outer surface of the plate portion.

The insert-molding may be also performed on a wire-connection portion of the terminal fitting and a waterproof cover portion provided over wire cover in addition to the plate portion.

According to the present invention, it is possible to provide a connector being capable of reducing the number of components to reduce costs, facilitating the component control, and realizing saving the space.

### BRIEF DESCRIPTION OF THE DRAWINGS

FIG. 1 a cross-sectional view (essential part enlarged diagram in a circle) illustrating a part of a shield connector according to a first embodiment of the present invention.

FIGS. 2A and 2B illustrate a terminal fitting according to the first embodiment of the present invention. FIG. 2A is an enlarged cross-sectional view of a part of a plate portion of the terminal fitting. FIG. 2B is a cross-sectional view of a recessed portion of the terminal fitting.

FIGS. 3A and 3B illustrate the terminal fitting and a wire terminal according to the first embodiment of the present invention. FIG. 3A is a perspective view illustrating a state where the terminal fitting is connected to the wire terminal. FIG. 3B is a perspective view illustrating a waterproof cover portion on which primary molding has been performed.

FIG. 4 is a perspective view illustrating a connector housing on which secondary molding has been performed.

FIG. 5 is a perspective view illustrating a shield connector in an assembly completed state.

FIGS. 6A and 6B are cross-sectional views illustrating recessed portions according to a second embodiment of the present invention.

FIGS. 7A and 7B are cross-sectional views illustrating recessed portions according to a third embodiment of the present invention.

FIGS. 8A and 8B are cross-sectional views illustrating recessed portions according to a fourth embodiment of the present invention.

FIGS. 9A and 9B are cross-sectional views illustrating recessed portions according to a fifth embodiment of the present invention.

FIGS. 10A and 10B are cross-sectional views illustrating recessed portions according to a sixth embodiment of the present invention.

FIG. 11 is a perspective view illustrating a conventional shield connector.

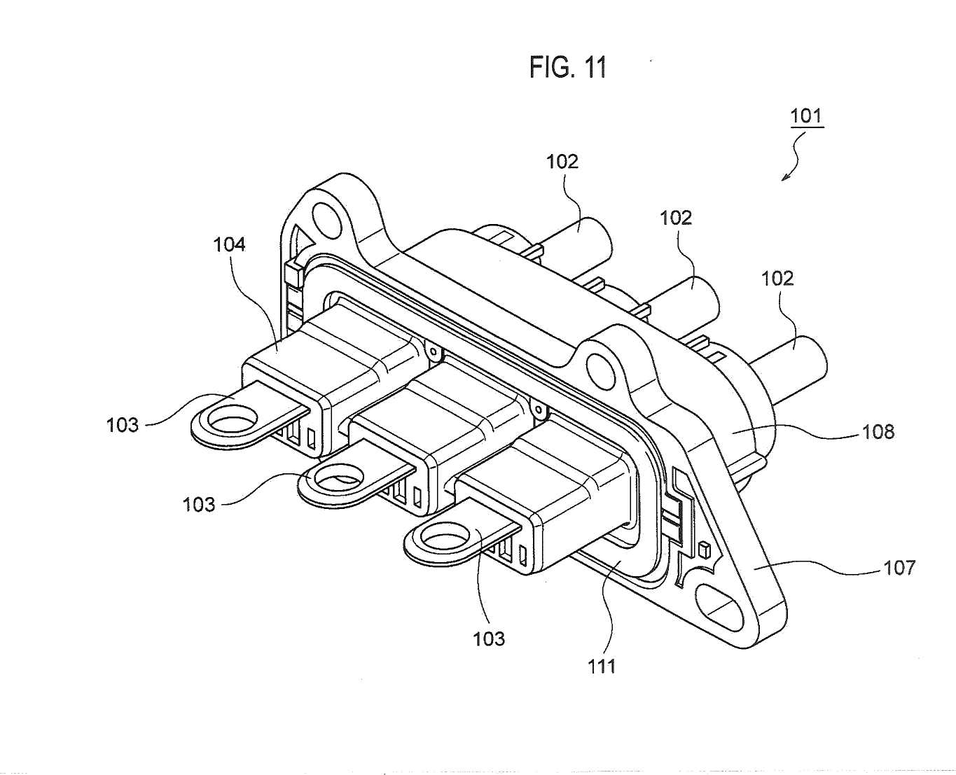

FIG. 12 is a cross-sectional view of FIG. 11.

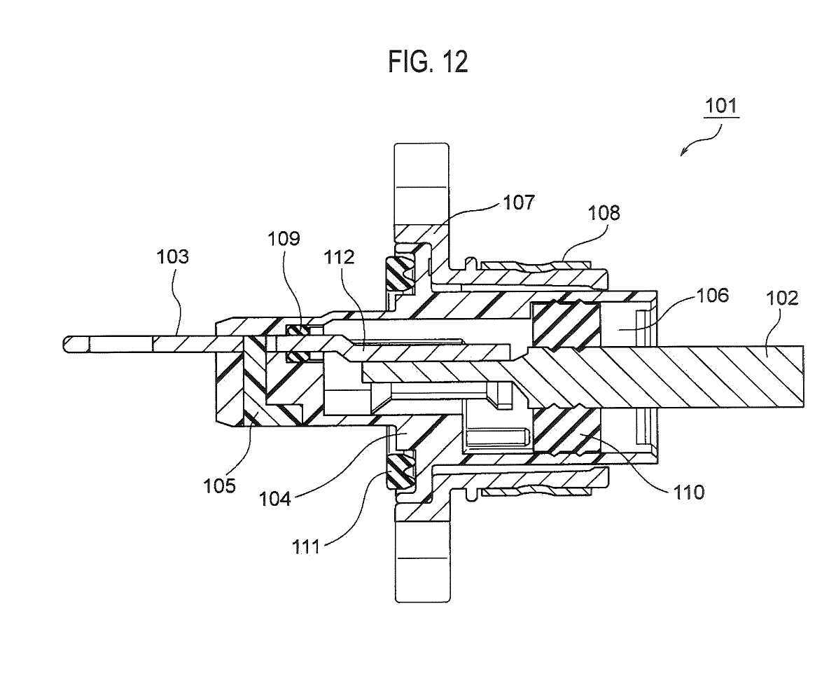

### DESCRIPTION OF THE EMBODIMENTS

The connector according to the embodiment of the present invention includes a terminal fitting including a plate portion formed with a plurality of recessed portions, and a resin connector housing. Further, the connector is formed by insert-molding the plate portion of the terminal fitting to the connector housing.

### First Embodiment

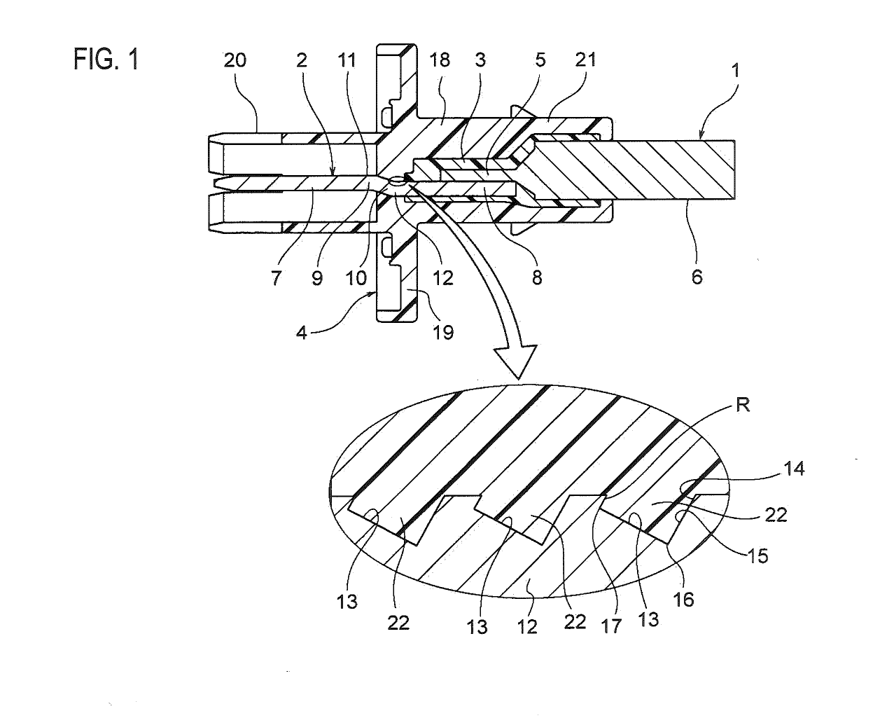

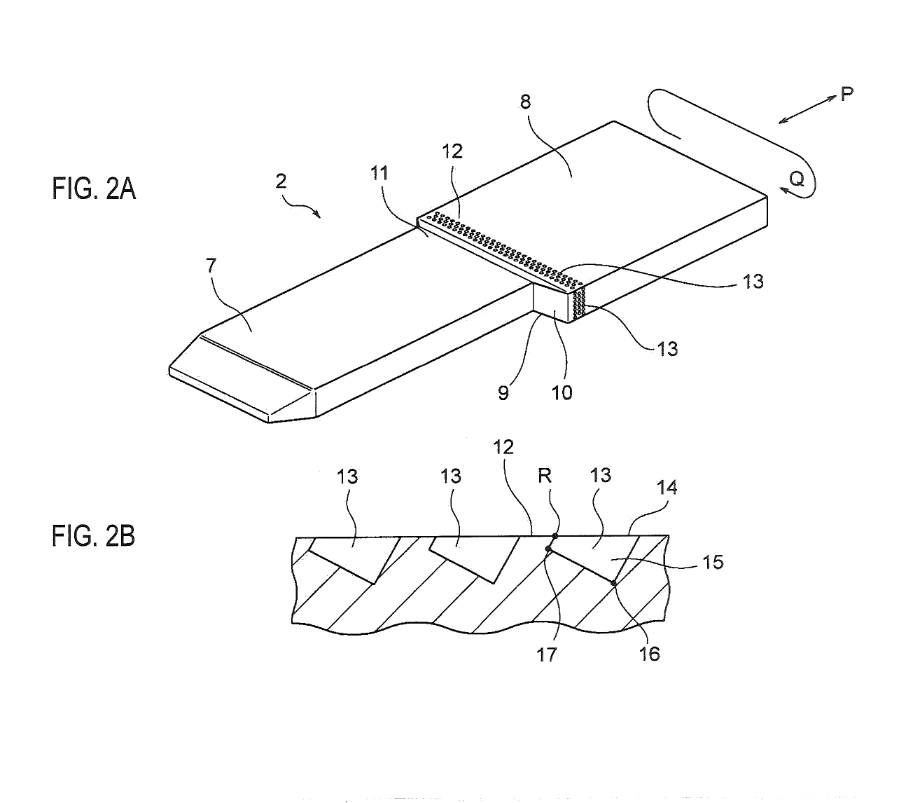

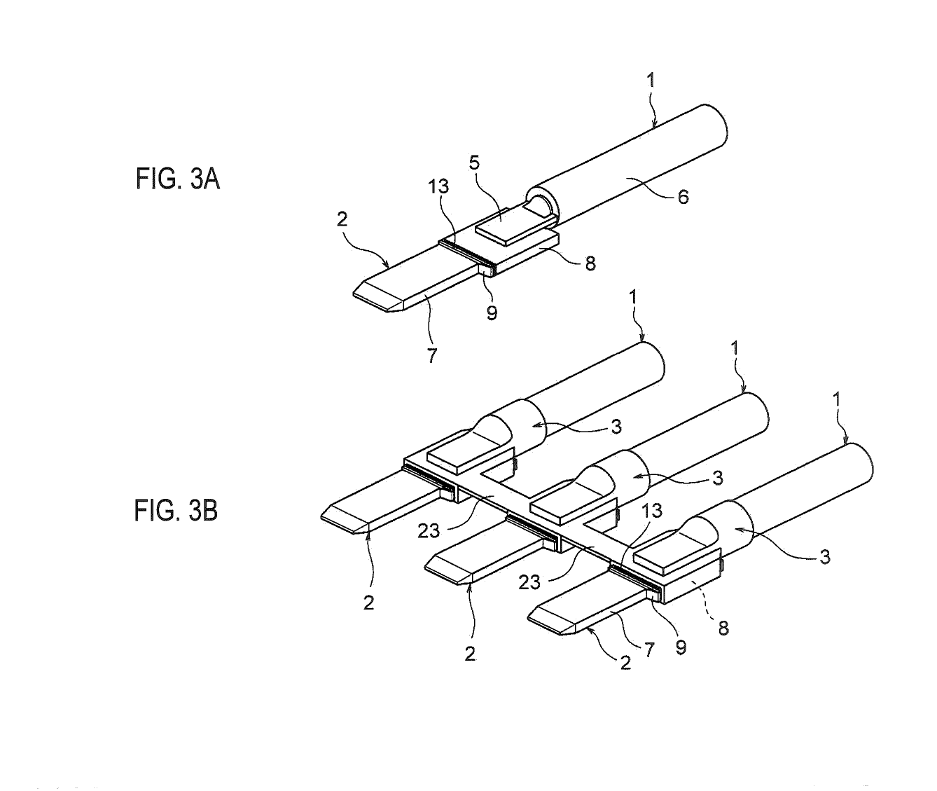

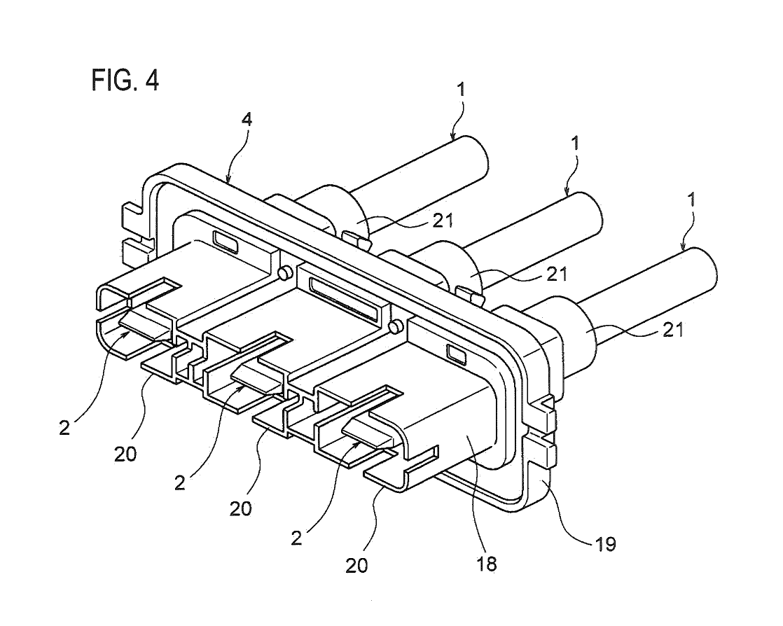

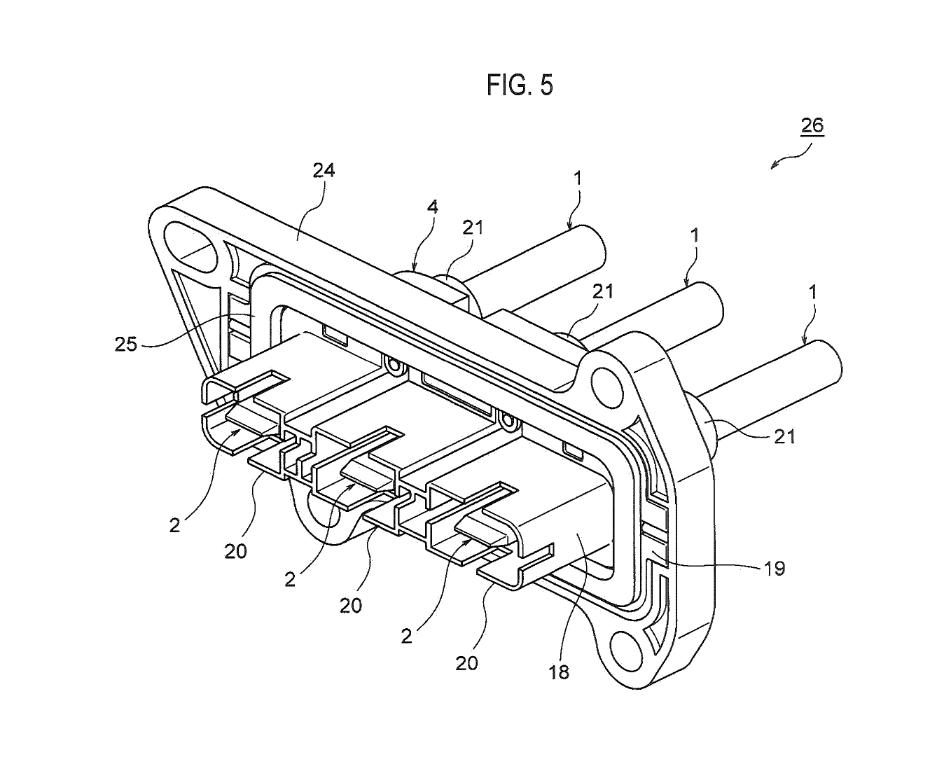

With reference to figures, a first embodiment of the present invention will be described below. FIG. 1 is a cross-sectional view of a part of a shield connector according to the present embodiment. Further, FIGS. 2A and 2B illustrate a terminal fitting. FIGS. 3A and 3B are perspective views illustrating a wire terminal and a waterproof cover portion. FIG. 4 is a perspective view of connect housing. FIG. 5 is a perspective view of a shield connector.

FIG. 1 illustrates a part of a shield connector (refer to FIG. 5 for a shape of an outer appearance of the shield connector). The shield connector is an example of a connector according to the present invention. Reference numerals 1, 2, 3 and 4 in FIG. 1 denote a high-voltage wire, a terminal fitting, a waterproof cover portion, and a connector housing, respectively.

The high-voltage wire 1 is, for example, a conductive path for high voltage that electrically connects an inverter unit with a motor unit mounted in a vehicle (not shown). When the above-described unit is used, for example, three high-voltage wires 1 are used. The high-voltage wire 1 includes a conductor 5, and an insulator 6 (wire cover) covering the conductor 5. The high-voltage wire 1 is formed to have a circular shape in cross section. The terminal of the high-voltage wire 1 is processed such that the insulator 6 is removed by a predetermined length to expose the conductor 5. The conductor 5 is made from aluminum, aluminum alloy, copper, or copper alloy. Herein, a conductive structure for making a twisted line is adopted. However, the conductive structure of the present invention is not limited to the structure for making the twisted line.

The terminal fitting 2 is formed by press-working a metal plate made from copper or copper alloy. The terminal fitting 2 is formed in a band-plate shape having a step in the middle of the terminal fitting 2. The terminal fitting 2 includes an electrical-contact portion 7 connecting with a mating terminal (not shown), a wire-connection portion 8 to which the conductor 5 of a terminal of the high-voltage wire 1 is connected, and a link portion 9 for the electrical-contact portion 7 and the wire-connection portion 8.

The link portion 9 is formed in the middle of the terminal fitting 2. The link portion 9 is formed in a substantially crank shape including a step portion 10, a plate portion 11 arranged at an electrical-contact portion 7 side, and a plate portion 12 arranged at a wire-connection portion 8 side, having the step portion 10 between the plate portion 11 and the plate portion 12. The plate portion 12 at the wire-connection portion 8 side is formed with a plurality of recessed portions 13. An arrow P illustrated in FIG. 2A is defined as an axis direction of the terminal fitting 2, and an arrow Q is defined as a peripheral direction of the terminal fitting 2 and the plate portion 12 for descriptions below.

A plurality of recessed portions 13 is formed at predetermined positions on an outer surface of the plate portion 12 in an entire peripheral direction (arrow Q). As illustrated in FIG. 2B, the recessed portion 13 includes an opening 14, an intermediate portion 15, and a bottom portion 16. The recessed portion 13 has a cross-sectional shape in which at least a part 17 (in other words, apart at a terminal tip end side in a structure forming the recessed portion 13) of the intermediate portion 15 or the bottom portion 16 displaces outward from a position (plane surface position, in other words, a position of an end of the opening 14) R of the opening 14 on a surface of the plate portion 12, with respect to the opening 14. In other words, on the cross section including a depth direction of the recessed portion 13, at least the part 17 of the intermediate portion 15 or the bottom portion 16 is located outside of the position R at the end of the opening 14 viewed from a center (inner portion, inside) of the recessed portion 13.

The above-described part 17 in the recessed portion 13 is formed as a part arranged at a tip end side of the terminal fitting 2, in other words, as a part arranged at an electrical-contact portion 7 side. Further, the part 17 is also formed as a part arranged at a side where water or the like comes in. The part 17 is formed at a position where the bottom portion 16 is not viewed from the opening 14. A part of the opening 14 at the position R is formed as a “barb portion (overhanging portion)” or a “lid portion” of the part 17. Therefore, performance for preventing liquid such as water and oil from coming in can be improved.

The bottom portion 16 is arranged inside of the position R of the opening 14, for example.

The recessed portion 13 is alternately arranged in a plurality of rows. According to the present embodiment, three rows are formed, and recessed portions 13 are staggered with respect to adjacent rows. Further, recessed portions 13 are arranged to align in a direction obliquely crossing an axis direction (arrow P). Such an arrangement always blocks the water or the like from passing through a second row, or third row by the recessed portion 13, even if it should pass through a first row. In other words, since the recessed portions 13 always exist in a flow path of the water or the like, the performance for preventing the water or the like from coming in can be improved.

The recessed portions 13 are formed on the plate portion 12 in the entire peripheral direction (arrow Q). Therefore, the water or the like can be blocked from coming into the wire-connection portion 8 side.

The plurality of recessed portions 13 is formed within a range not affecting strength and electric resistance of the terminal fitting 2. As being understood from the above descriptions, the recessed portions 13 are not formed only on one surface (e.g., only the upper surface) of the plate portion 12.

As illustrated in FIG. 1, the waterproof cover portion 3 is covered with resin material formed over the wire-connection portion 8 of the terminal fitting 2 and the insulator 6 of the high-voltage wire 1. The waterproof cover portion 3 is formed not to expose the conductor 5. The waterproof cover portion 3 is formed by primary molding described below.

The connector housing 4 is an insulating resin-molded product. The connector housing 4 includes a housing main body portion 18 and a flange portion 19 continuously molded in the middle of the housing main body portion 18.

The flange main body portion 19 is integrally formed with a connector fitting portion 20 where the electrical-contact portion 7 of the terminal fitting 2 is arranged inside and an insert portion 21 where the link portion 9 of the terminal fitting 2 and the waterproof cover portion 3 are insert-molded. In the insert portion 21, the resin material enters the recessed portion 13 and becomes solid to form a plurality of terminal fixing portions 22. The terminal fixing portions 22 are formed in a shape to completely embed recessed space of the recessed portion 13.

Subsequently, based on the above-described configuration and structure, an assembly process (work) of the shield connector will be described.

As illustrated in FIG. 3A, in a first process, a work is performed for connecting the conductor S of the terminal of the high-voltage wire 1 to the wire-connection portion 8 of the terminal fitting 2. As a connection method, methods of welding, adhesion, and soldering are appropriately adopted.

As illustrated in FIG. 3B, in a second process, a work is performed for forming the waterproof cover portion 3 to stride the wire-connection portion 8 of the terminal fitting 2 and the insulator 6 of the high-voltage wire 1. The waterproof cover portion 3 is formed by the resin-molding (primary molding) by the insert-molding. When the molding is performed, a bridge portion 23 for linking the waterproof cover potions 3 is integrally formed. By formation of the bridge portion 23, positions of three terminal fittings 2 can be stabilized and, thus, a following process can be facilitated.

As illustrated in FIG. 4, in a third process, a work of resin-molding (secondary molding) the connector housing 4 is performed. When the connector housing 4 is molded, terminal portions of the terminal fitting 2 and the high-voltage wire 1 are insert-molded via the link portion 9 and the waterproof cover portion 3. By the insert-molding, the resin material enters the recessed portion 13 as illustrated in FIG. 1 and becomes solid to form a plurality of terminal fixing portions 22. The terminal fitting 2 is fixed along with the resin-molding of the connector housing 4.

As illustrated in FIG. 5, in a fourth process, a work of assembling a metal shield shell 24, a rubber unit packing 25 and the like to the connector housing 4 is performed. Further, a work of fixing a cylindrical shielding member (not shown) collectively covering the three high-voltage wires 1 to the shield shell 24 is also performed. The shielding member is fixed using a metal shield ring (not shown). When the process is sequentially performed up to the fourth process, assembling the shield connector 26 is completed.

As described above with reference to FIGS. 1 to 5, according to the shield connector 26 of the present invention, the terminal fitting 2 is fixed to the connector housing 4 even without using a dedicated fixing component. This is because the plurality of recessed portions 13 is formed on the plate portion 12 of the terminal fitting 2, and the resin material enters the plurality of recessed portion 13 by the insert-molding and becomes solid to form the plurality of terminal fixing portions 22.

Further, with the shield connector 26 of the present invention, even without using a dedicated waterproof component such as an O ring, it is possible to waterproof between the terminal fitting 2 and the connector housing 4. This is because the plurality of recessed portions 13 in a unique shape is formed on the plate portion 12 of the terminal fitting 2, further, the plurality of recessed portions 13 is formed over entire periphery of the plate portion 12, and, as descried above, the resin material enters the plurality of recessed portions 13 to form the plurality of terminal fixing portions 22.

Therefore, with the shield connector 26 according to the present embodiment, the conventional fixing component and waterproof component are not needed. In other words, the conventional fixing components and waterproof components can be reduced. Since the shield connector 26 uses the less number of components than the conventional connector, costs for components and assembling can be reduced. Further, components control can be facilitated and space can be saved.

### Second Embodiment

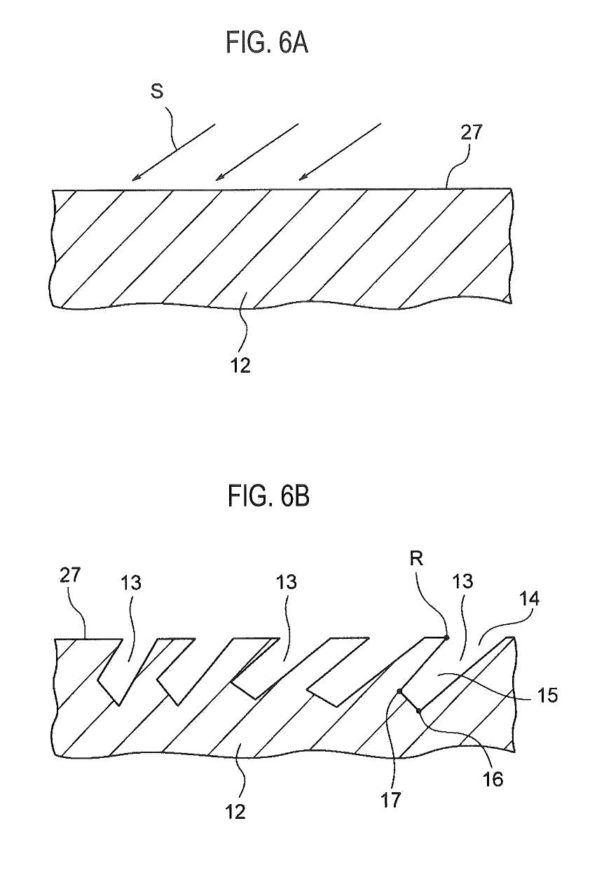

With reference to figures, a second embodiment will be described below. FIGS. 6A and 6B are cross-sectional views illustrating the recessed portions according to the present embodiment.

The recessed portion 13 according to the present embodiment is formed by performing a process described below. In other words, as illustrated in FIGS. 6A and 6B, the recessed portion 13 is formed by processing the outer surface (surface) 27 of the plate portion 12 to be recessed in an oblique direction as indicated with an arrow S. The processing adopts a processing method of blowing out polishing agent having a fine diameter of a particle such as sand and being mixed with compressed air.

The recessed portion 13 has a cross-sectional shape in which the part 17 (and bottom portion 16) of the intermediate portion 15 displaces outward from the position R of the opening 14, with respect to the opening 14. Therefore, similar effects to those of the first embodiment can be obtained from the recessed portion 13 according to the second embodiment.

### Third Embodiment

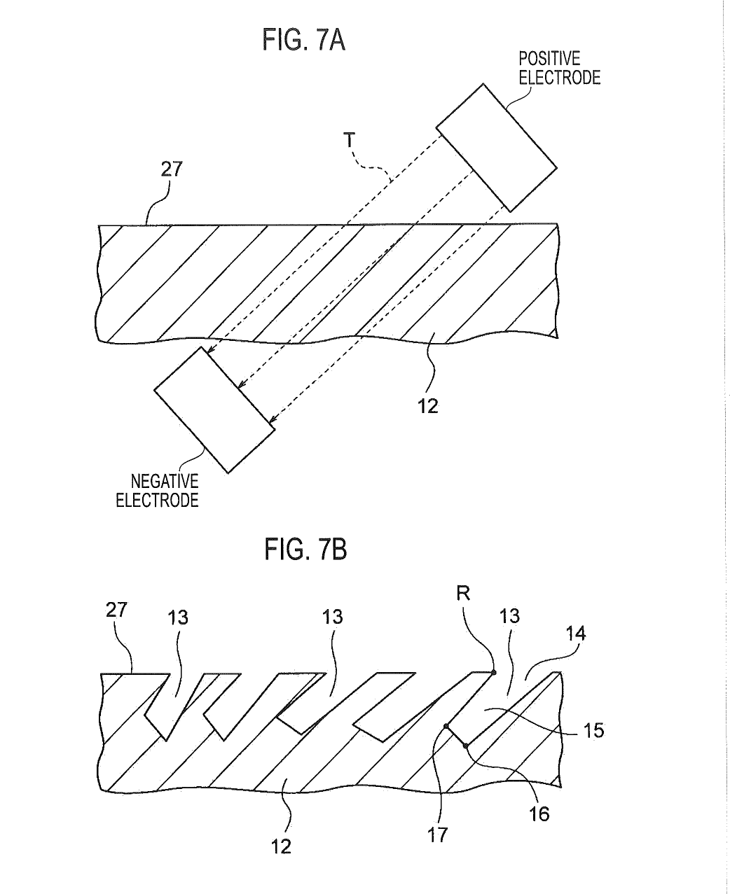

With reference to figures, a third embodiment will be described below. FIGS. 7A and 7B are cross-sectional views illustrating the recessed portions according to the present embodiment.

The recessed portion 13 according to the present embodiment is formed by performing a process described below. In other words, as illustrated in FIGS. 7A and 7B, the recessed portion 13 is formed by processing the outer surface 27 of the plate portion 12 to be recessed in an oblique direction indicated as an arrow T. The processing adopts a processing method (discharging process) of processing the outer surface 27 of the plate portion 12 by applying an electrode thereto. Such processing contributes to reducing the number of components, similarly to other embodiments.

The recessed portion 13 has a cross-sectional shape in which the part 17 (and bottom portion 16) of the intermediate portion 15 displaces outward from the position R of the opening 14, with respect to the opening 14. Therefore, similar effects to those of the first embodiment can be obtained from the recessed portion 13 according to the third embodiment.

### Fourth Embodiment

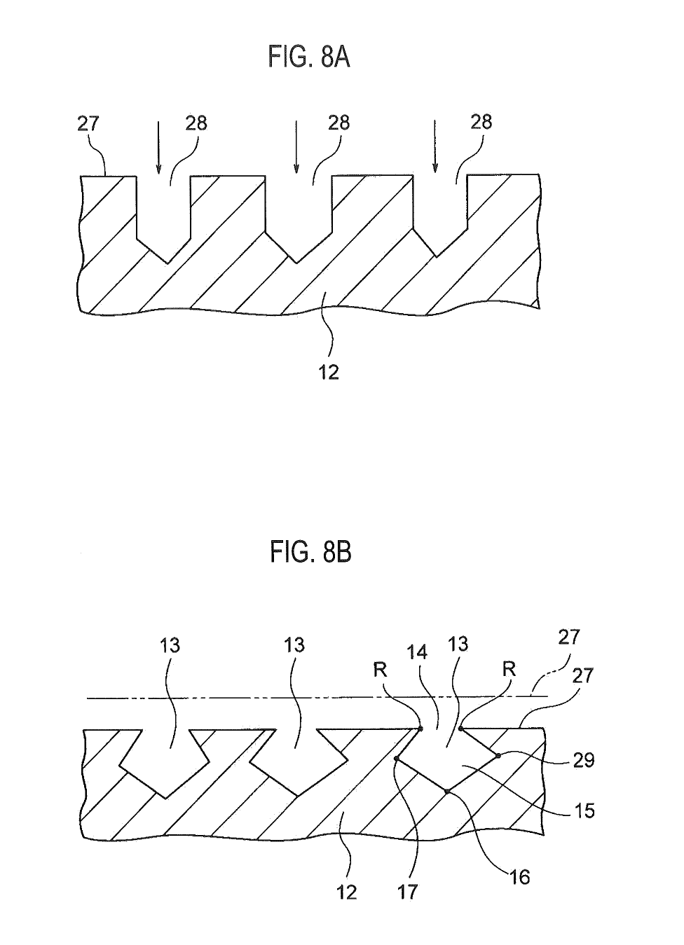

With reference to figures, a fourth embodiment will be described below. FIGS. 8A and 8B are cross-sectional views illustrating the recessed portions according to the present embodiment.

The recessed portion 13 according to the present embodiment is formed by performing a process described below. In other words, as illustrated in FIGS. 8A and 8B, the recessed portion 13 is formed by first forming a plurality of recesses 28 on the outer surface 27 of the plate portion 12 and, subsequently, performing an additional processing of applying pressure onto the outer surface 27 to reduce a thickness of a plate.

As illustrated in FIG. 8B, the recessed portion 13 has a cross-sectional shape in which the part 17 and other parts 29 of the intermediate portion 15 displaces outward from the position R of the opening 14, with respect to the opening 14. Therefore, similar effects to those of the first embodiment can be obtained from the recessed portion 13 according to the fourth embodiment.

### Fifth Embodiment

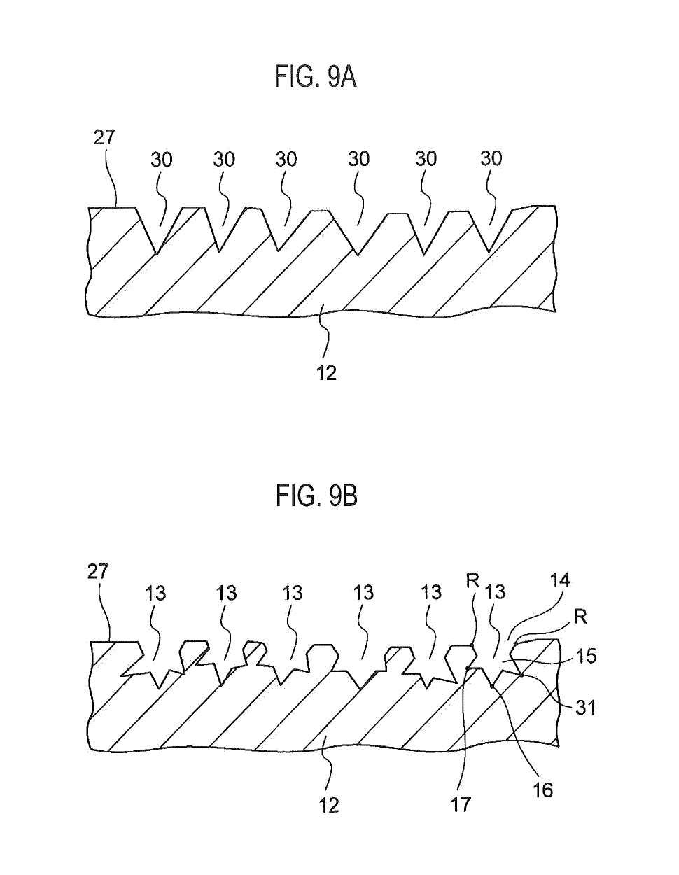

With reference to figures, a fifth embodiment will be described below. FIGS. 9A and 9B are cross-sectional views illustrating the recessed portions according to the present embodiment.

The recessed portion 13 according to the present embodiment is formed by performing a process and a treatment described below. In other words, as illustrated in FIGS. 9A and 9B, the recessed portion 13 is formed by first forming a plurality of recesses on the outer surface 27 of the plate portion 12, and subsequently, by performing a chemical treatment in which the plate portion 12 is immersed in thick chemical liquid for a short time. If the plate portion 12 is immersed into the chemical liquid, small recesses and protrusions are generated on the recess 30. Such formation contributes to reducing the number of components, similarly to other embodiments.

As illustrated in FIG. 9B, the recessed portion 13 has a cross-sectional shape in which the part 17 (and other parts 31) of the intermediate portion 15 displaces outward from the position R of the opening 14, with respect to the opening 14. Therefore, similar effects to those of the first embodiment can be obtained from the recessed portion 13 according to the fifth embodiment.

### Sixth Embodiment

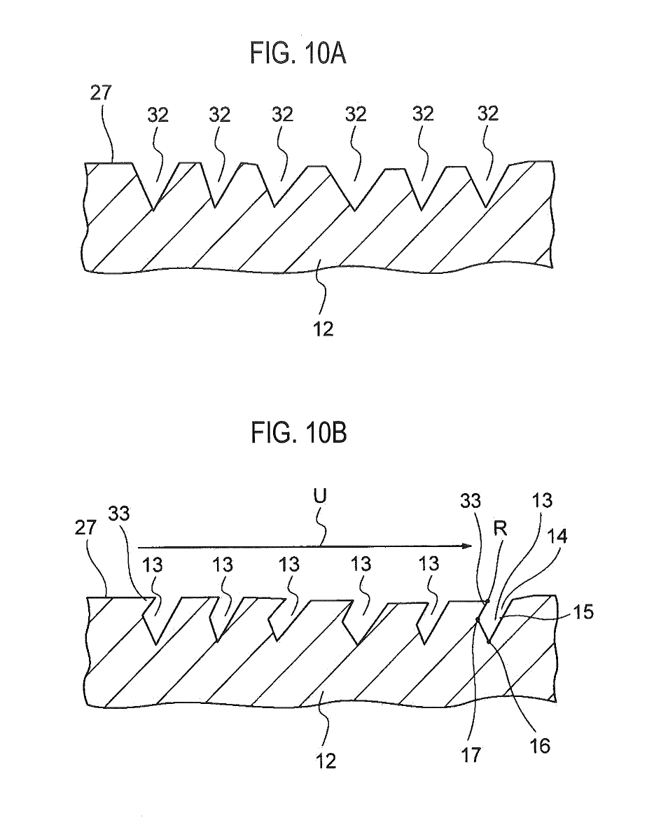

With reference to figures, a sixth embodiment will be described below. FIGS. 10A and 10B are cross-sectional views illustrating the recessed portions 13 according to the present embodiment.

The recessed portion 13 according to the present embodiment can be formed by performing a process described below. In other words, as illustrated in FIGS. 10A and 10B, the recessed portion 13 can be formed by first performing rough polishing on the outer surface 27 of the plate portion 12 to form a plurality of recesses 32 and, subsequently, additionally performing fine polishing in an arrow U direction. When the fine polishing is performed in the arrow U direction, a barb portion 33 (lid portion) is formed.

As illustrated in FIG. 10B, the recessed portion 13 has an illustrated cross-sectional shape in which the part 17 of the intermediate portion 15 displaces outward from the position R of the opening 14, with respect to the opening 14. Therefore, similar effects to those of the first embodiment can be obtained from the recessed portion 13 according to the sixth embodiment.

According to the above-described embodiments, the insert-molding can be performed on the wire-connection portion 8 of the terminal fitting 2 and the waterproof cover portion 3 over the insulator 6 (wire cover). Therefore, even without using the conventional waterproof component, it is possible to prevent a water leakage between the wire and the connector housing. In other words, the waterproof cover portion 3 (or the molding) contributes to reducing the number of components.

Further, the present invention can be changed within a range not changing the gist of the present invention.

What is claimed is:

1. A connector, comprising:
a terminal fitting including a plate portion; and
a resin connector housing,
wherein the terminal fitting is fixed by insert-molding the plate portion to the connector housing;
wherein the plate portion has a plurality of recessed portions arranged and formed at predetermined positions on an outer surface of the plate portion in an entire peripheral direction; and
wherein each of the plurality of recessed portions has a cross-sectional shape in which at least a part of an intermediate portion or a bottom portion displaces outward from a position of an opening of the recessed portion, with respect to the opening.

2. The connector according to claim 1, wherein the plurality of recessed portions is alternately arranged in a plurality of rows.

3. The connector according to claim 1, wherein the plurality of recessed portions is formed by processing the outer surface of the plate portion to be recessed in an oblique direction.

4. The connector according to claim 1, wherein the plurality of recessed portions is formed by an additional processing or a chemical treatment after the formation of recess on the outer surface of the plate portion.

5. The connector according to claim 1, wherein the insert-molding is also performed on a wire-connection portion of the terminal fitting and a waterproof cover portion provided over a wire cover, in addition to the plate portion.
